(19) United States
(12) Patent Application Publication
(10) Pub. No.: US 2008/0256484 A1
(43) Pub. Date: Oct. 16, 2008

(54) Techniques for aligning and positioning objects

(75) Inventors: Tara Kraft, Seattle, WA (US); Matt Wood, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/786,503

(22) Filed: Apr. 12, 2007

(51) Int. Cl. G06F 3/048

(52) U.S. Cl. 715/799

(57) ABSTRACT

Techniques for aligning and positioning objects are described. A computer system employing such techniques may comprise a display to present a graphical user interface including a pointer to select a movable object and a guide to align a selected object at a target position. The guide may comprise one or more pixels configured with a coefficient for modifying a standard object movement rate of the selected object. The selected object may be positioned at any pixel configured with the coefficient. The computer system may comprise an input device to receive an object selection and user movement to position the selected object at the target position on the graphical user interface and an alignment module to translate a user movement rate into a corresponding object movement rate according to the coefficient when an edge of the selected object intersects with any pixel configured with the coefficient. Other embodiments are described and claimed.

### BACKGROUND

Desktop publishing applications may provide guides to assist users when aligning and positioning objects on a graphical user interface (GUI). By default, such guides typically exhibit a “snapping” behavior where an object jumps automatically to the guide when positioned within some predetermined distance of the guide. A significant drawback to this approach is that objects may not be positioned less than the predetermined distance from the guide resulting in blank and unusable space. Snapping also contributes to a jumpy look when an object is positioned, and the ability to disable or change such snapping behavior is not readily apparent to users.

Some desktop applications offer design guidance to users for creating documents with a professional appearance. In many cases, however, guidance is provided only after the user has completed some action and not during the authoring process such as when a user changes a template or works without a template. Current design guidance for boundaries and guides is typically static and offers only limited feedback regarding spatial relationships.

The ability to provide design guidance during the authoring process is limited by the snapping behavior of guides. Because snapping creates blank spaces and limits the placement of objects on the page, guides are disruptive and must be limited to a small scope of influence on the page. Therefore, there may be a need for improved techniques for aligning and positioning objects to solve these and other problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are directed to techniques for aligning and positioning objects. In one or more embodiments, a computer system employing such techniques may comprise a display to present a graphical user interface including a pointer to select a movable object and a guide to align a selected object at a target position. The guide may comprise one or more pixels configured with a coefficient for modifying a standard object movement rate of the selected object. The selected object may be positioned at any pixel configured with the coefficient. The computer system may comprise an input device to receive an object selection and user movement to position the selected object at the target position on the graphical user interface and an alignment module to translate a user movement rate into a corresponding object movement rate according to the coefficient when an edge of the selected object intersects with any pixel configured with the coefficient. Other embodiments are described and claimed.

### BRIEF DESCRIPTION OF THE DRAWINGS

FIG. 1 illustrates one embodiment of a computer system.

FIGS. 2A-D illustrate various embodiments of graphical user interfaces.

FIGS. 3A and 3B illustrate various embodiments of graphical user interfaces.

FIG. 4 illustrates one embodiment of a logic flow.

FIG. 5 illustrates one embodiment of a computing system architecture.

### DETAILED DESCRIPTION

Various embodiments are directed to techniques for aligning and positioning objects. Numerous specific details are set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” are not necessarily all referring to the same embodiment.

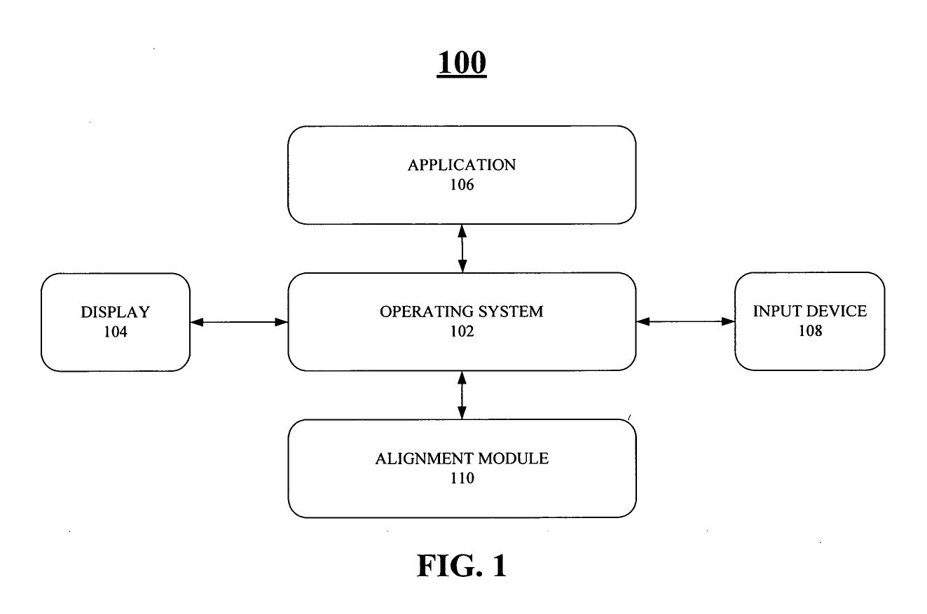

FIG. 1 illustrates an exemplary computer system 100 suitable for implementing techniques for aligning and positioning objects according to one or more embodiments. The computer system 100 may be implemented, for example, as various devices including, but not limited to, a personal computer (PC), server-based computer, laptop computer, notebook computer, tablet PC, handheld computer, personal digital assistant (PDA), mobile telephone, combination mobile telephone/PDA, television device, set top box (STB), consumer electronics (CE) device, any other suitable computing or processing system which is consistent with the described embodiments.

As illustrated, the computer system 100 is depicted as a block diagram comprising several functional components or modules which may be implemented as hardware, software, or any combination thereof, as desired for a given set of design parameters or performance constraints. Although FIG. 1 may show a limited number of functional components or modules for ease of illustration, it can be appreciated that additional functional components and modules may be employed for a given implementation.

As used herein, the terms “component” and “system” are intended to refer to a computer-related entity, either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation.

Various embodiments may be described in the general context of computer-executable instructions, such as program modules, being executed by a computer. Generally, program modules include any software element arranged to perform particular operations or implement particular abstract data types. Some embodiments also may be practiced in distributed computing environments where operations are performed by one or more remote processing devices that are linked through a communications network. In a distributed computing environment, program modules may be located in both local and remote computer storage media including memory storage devices.

As shown in FIG. 1, the computer system 100 may comprise an operating system 102 coupled to a computer display 104, an application 106, an input device 108, and an alignment module 110. The operating system 102 may be arranged to control the general operation of the computer system 100 and may be implemented, for example, by a general-purpose operating system such as a MICROSOFT® operating system, UNIX® operating system, LINUX® operating system, or any other suitable operating system which is consistent with the described embodiments.

The computer display 104 may be arranged to present content to a user and may be implemented by any type of suitable visual interface or display device. Examples of the computer display 104 may include a computer screen, computer monitor, liquid crystal display (LCD), flat panel display (FPD), cathode ray tube (CRT), and so forth.

The computer system 100 may be configured to execute various computer programs such as application 106. In one or more embodiments, the application 106 may be may be implemented as a desktop publishing application, graphical design application, presentation application, chart application, spreadsheet application, or word processing application. In various implementations, the application 106 may comprise an application program forming part of a Microsoft Office suite of application programs. Examples of such application programs include Microsoft Office Publisher, Microsoft Office Visio, Microsoft Office PowerPoint, Microsoft Office Excel, Microsoft Office Access, and Microsoft Office Word. In some cases, application programs can be used as stand-alone applications, but also can operate in conjunction with server-side applications, such as a Microsoft Exchange server, to provide enhanced functions for multiple users in an organization. Although particular examples of the application 106 have been provided, it can be appreciated that the application 106 may be implemented by any other suitable application which is consistent with the described embodiments.

The input device 108 may be arranged to receive input from a user of a computer system 100. In one or more embodiments, the input device 108 may be arranged to allow a user to select and move objects within a GUI presented on the computer display 102. In such embodiments, the input device 108 may be implemented as a mouse, trackball, touch pad, stylus, tablet PC pen, touch screen, and so forth.

In one or more embodiments, the application 106 may be arranged to present a GUI on the computer display 104. The GUI may be used, for example, as an interface to display various views of an electronic document, web page, template, and so forth, and receive operator selections or commands. During the authoring process, an operator, author or user may interact with the GUI to manipulate various graphics to achieve a desired arrangement. In some implementations, the GUI may be subsequently printed and/or published by the user after completion of the authoring process.

The GUI may display various graphics to a user including a pointer to select a movable object and a guide to align a selected object at a target position. The object generally may comprise any two-dimensional image capable of being selected and moved within the GUI. Examples of an object include, but are not limited to, a picture, a shape, a graphic, text, and so forth. The object may be moved using a “click and drag” technique where the pointer is positioned over the object, a mouse click selects the object, and the selected object is moved within the GUI to a new location.

In various implementations, an object may be defined by a rectangular bounding box. The rectangular bounding box may comprise, for example, nine points including the four vertices and four midpoints of the boundary and the center of the object. In one or more embodiments, each of the nine points of the rectangular bounding box may be used individually to determine the position of the object and to make movement calculations. It can be appreciated that when moving an object, the pointer may be placed at various positions on the object. As such, the pointer location may be too unpredictable to be used as a reference. Accordingly, using the points of the bounding box may result in more accurate positioning and calculations.

A guide may be structured and arranged to assist users when aligning and positioning objects on a GUI. In one or more embodiments, the guide may comprise a plurality of collinear guide pixels and may be implemented, for example, by at least one of a guideline, a guide region, a shape guide, and a text baseline. The guide may comprise, for example, a horizontal and/or vertical guideline implemented as a ruler, margin, edge, gridline, and so forth. In some embodiments, the guide may comprise a two-dimensional guide region such as a shape outline or solid shape. The guide also may comprise a shape guide comprising a vertical or horizontal guideline extending from a corner or midpoint of an object. The shape guide may be used for alignment between objects and, in some implementations, may be displayed only when an edge or midpoint of a moving object is aligned with the edge or midpoint of another object. The guide may comprise a text baseline comprising a horizontal or vertical line upon which text sits and under which text letter descenders extend. Although particular examples of a guide have been provided, it can be appreciated that guides may be implemented by any other suitable structure which is consistent with the described embodiments.

In various embodiments, a guide may implement one or more configurable forces in lieu of traditional snapping to allow smoother object movement and to enable guides to affect a greater portion of the GUI. In such embodiments, one or more points of the rectangular bounding box of the object may be affected by such forces. In many cases, the guide may comprise a one pixel wide guideline exhibiting either a resistive or attractive force. In others cases, a guide may comprise a two-dimensional shape outline (e.g., one pixel wide boundary) exhibiting force at the perimeter of the shape or a solid shape exhibiting continuous force over the entire area of the shape.

In general, when an object is moved, user movement (e.g., mouse or pointer movement) is translated into a corresponding object movement on a GUI. For standard pixels, user movement is translated into a standard object movement rate. In various embodiments, one or more pixels of a guide may be configured with a coefficient that modifies (e.g., slows or accelerates) the standard object movement rate of a selected and moving object. It can be appreciated that the selected object may pass through and be positioned at any pixel that is configured with the coefficient.

In some embodiments, one or more pixels of a guide may be configured with a friction coefficient (μ). When an edge of the object intersects with the guide, user movement is subjected to the friction coefficient (μ), and the object movement rate is modified so that object is slowed or paused from the perspective of the user.

The friction coefficient (μ) may have the effect of virtually subdividing a single pixel into a number of smaller “frixels.” The number of frixels can be configured to provide more or less friction depending on the desired implementation. In general, the guide will provide no visual indication of the frixels to the user. In one or more embodiments, the same amount of input user movement (e.g., mouse movement) required to move the object through a single normal pixel may be required to move the object through a single frixel. Accordingly, user movement is translated into less movement on the GUI providing the user with additional time to precisely position the object.

In some implementations, the friction coefficient (μ) may comprise a horizontal component (μ_{H}) and a vertical component (μ_{V}). For example, a pixel divided vertically into sections exhibits horizontal friction. Likewise, a pixel divided horizontally into sections exhibits vertical friction. If the horizontal component (μ_{H}) and the vertical component (μ_{V}) are equal, the pixel exhibits uniform, non-directional friction.

In some embodiments, one or more pixels of a guide may be configured with a gravity coefficient (g). The pixels configured with the gravity coefficient (g) may define a region of influence or field of gravity adjacent to a plurality of collinear guide pixels (e.g., horizontal or vertical guideline). The gravity coefficient (g) may accelerate the corresponding object movement rate in a direction toward the plurality of collinear guide pixels when an edge of the selected object intersects with the region of influence.

When an edge of the object intersects with the region of influence, user movement is subjected to the gravity coefficient (g), and the object movement is modified so that object is pulled in the direction of the guide. The gravity coefficient (g) may accelerate the corresponding object movement rate in a direction toward the plurality of collinear guide pixels. It can be appreciated that the object is not instantly jumped from one position to the guide. Rather, the input user movement (e.g., mouse movement) is translated into accelerated movement of the object toward the guide. The object passes through and may be positioned at every pixel within the region of influence. Even when accelerated, the object ultimately may be stopped within the region of influence.

In one or more embodiments, all object movement is pulled toward the collinear guide pixels when the object is within the region of influence. For example, upward object movement toward a horizontal guideline may be accelerated. Likewise, object movement away from the guide may be hindered. For example, downward object movement away from the horizontal guideline may be resisted so that extra or faster user movement in the opposite direction of the pull is needed to move the object. In addition, object movement parallel to the guide may be bent in the direction of the guide. For example, a vertical component may be added to lateral object movement parallel to a horizontal guideline so that the horizontal movement of the object will bend upwards toward the horizontal guideline.

The gravitational pull exerted by the region of influence may be strongest at the collinear guide pixels (e.g., horizontal or vertical guideline) and diminish evenly over distance. In such cases, the gravitation pull will be greater and the object movement rate will be faster as the object gets closer to collinear guide pixels. The gravitation pull may be configurable and determine the rate of acceleration. The number and arrangement of pixels defining the field of gravity may be configurable and determine the distance over which the gravitational pull fades and the limits of the region of influence.

In some implementations, the gravity coefficient (g) may be configured to provide no resistance to movement in a direction away from the field of influence. In such cases, the user movement rate may be translated into standard movement rate upon receiving user movement in a direction away from the collinear guide pixels even when the selected object is within the area of influence.

In some embodiments, one or more pixels of a guide may be configured as “quixels” which apply the gravity coefficient (g) only to actual components of user movement. In such embodiments, user movement rate may be translated into a corresponding object movement rate based on the distance between the object and the guide, the proportion of the movement corresponding to the direction of the guide, and whether the user movement is in a direction toward the guide or away from the guide. Because vertical and horizontal user movements are both factored, the influence of gravity implemented by quixels is limited in some cases.

The pixels configured with the gravity coefficient (g) may define a region of influence adjacent to a plurality of collinear guide pixels. The gravity coefficient (g) may comprise a toward factor (g_{T}) and an away factor (g_{A}) to apply to an object within the area of influence. The toward factor (g_{T}) may be applied to any user movement within a 90° angle on either side of a line extending between the object to the guide. The away factor (g_{A}) may be applied to any user movement within the opposite 180°.

Within the area of influence, user movement rate may be translated according to the toward factor (g_{T}) for user movement received in a direction perpendicular to and toward the collinear guide pixels. User movement rate may be translated according to the away factor (g_{A}) of the gravity coefficient (g) for user movement received in a direction perpendicular to and away from the collinear guide pixels. Regarding user movement in a direction parallel to the collinear guide pixels, however, the user movement rate may be translated into the standard object movement rate. For example, an object moved vertically and parallel to a vertical guideline will not experience horizontal gravity even if the object is within the region of influence. In contrast, any horizontal movement of the object would be accelerated toward the vertical guideline within the region of influence. In some cases, the away factor (g_{A}) can be turned off (e.g., g_{A}=1) so that user movement in a direction away from the guideline corresponds to the standard movement rate.

Referring again to FIG. 1, the alignment module 110 may be arranged to perform various techniques for aligning and positioning in accordance with one or more embodiments. The alignment module 110 may be implemented, for example, by a set of event-driven routines to enhance the application 106. In various implementations, the operating system 102 may be arranged to monitor user movement received from the input device 108 and to execute various computer programs and event-driven routines such as application 108 and alignment module 110. In some cases, the alignment module 110 may be built into the operating system 102 and/or the application 106.

In one or more embodiments, the alignment module I 10 may be arranged to translate a user movement rate into a corresponding object movement rate according to one or more coefficients when an edge of the selected object intersects with any pixel configured with the coefficients. In some implementations, one or more pixels of a guide may be configured with a friction coefficient (μ), and the alignment module 110 may be arranged to translate the user movement rate into a corresponding object movement rate which is slower than the standard object movement rate. For example, when an edge of the object intersects with the guide, the alignment module 110 may translate a user movement rate into corresponding object movement rate according to the friction coefficient (μ). In such cases, the object movement rate is modified so that object is slowed or paused from the perspective of the user.

In some embodiments, one or more pixels of a guide may be configured with a gravity coefficient (g). The pixels configured with the gravity coefficient (g) may define a region of influence adjacent to a plurality of collinear guide pixels, and the alignment module 110 may be arranged to translate the user movement rate into a corresponding object movement rate which is faster than the standard object movement rate. For example, when an edge of the object intersects with the region of influence, the alignment module I 10 may translate the user movement rate into a corresponding object movement rate according to gravity coefficient (g). In such cases, the object movement rate is modified so that the object increases speed and accelerates toward the collinear guide pixels. In some implementations, the alignment module 110 may be arranged to translate user movement rate into corresponding object rate which is slower than the standard movement rate when the selected object is within the area of influence upon receiving user movement in a direction away from the collinear guide pixels. In other implementations, the alignment module 110 may be arranged to translate user movement rate into the standard movement rate when the selected object is within the area of influence upon receiving user movement in a direction away from the collinear guide pixels.

In some embodiments, one or more pixels of a guide may be configured as quixels which apply the gravity coefficient (g) only to actual components of user movement. The pixels configured with the gravity coefficient (g) may define a region of influence adjacent to a plurality of collinear guide pixels. In such embodiments, the alignment module 110 may be arranged to translate user movement rate according to a toward factor (g_{T}) of the gravity coefficient (g) for user movement received in a direction perpendicular to and toward the collinear guide pixels. The alignment module 110 may be arranged to translate user movement rate according to an away factor (g_{A}) of the gravity coefficient (g) for user movement received in a direction perpendicular to and away from the collinear guide pixels. Upon receiving user movement in a direction parallel to the collinear guide pixels, however, the alignment module 110 may translate user movement rate into the standard object movement rate when the selected object is within the area of influence. In some cases, the alignment module I 10 may be arranged to translate user movement rate into the standard object movement rate for user movement in a direction away from the collinear guide pixels.

In one or more embodiments, a guide may comprise both a gravity coefficient (g) and a friction coefficient (μ). For example, the pixels configured with the gravity coefficient (g) may define a region of influence adjacent to a plurality of collinear guide pixels configured the friction coefficient (μ). In such embodiments, an object may be pulled in a direction toward the guide when in the region of influence according to the gravity coefficient (g) but may pause when intersecting and moving through the collinear guide pixels according to the friction coefficient (μ).

In various implementations, a given coefficient associated with a guide may be configured or changed to vary behavior of the guide. Accordingly, the amount of influence associated with a particular guide may be varied. In addition, different types of guides may be configured to exhibit different behavior. A guide may be configured with a higher or lower amount of friction depending on the type of guide or its use. For example, automatically displayed guides may implement a small amount of friction or gravity while user inserted guides may implement a large amount of friction or gravity.

In one or more embodiments, a template comprising one or more configurable guides may be presented to a user. In some implementations, multiple templates comprising various arrangements of guides may be provided allowing a user to select one or more guides from one or more templates. Guides may be built into document templates to provide a user with contemporaneous guidance during the authoring process of a document even when not actively moving objects or using the objects of a template.

Guides may be displayed automatically in response to object selection and user movement. In some cases, guides may be automatically displayed as an object is moved indicate alignment with other objects. For example, a guideline may appear when the edge of a moving object is aligned with a positioned object. The bounding boxes of the moving object and the positioned object may be aligned in several ways such as edge to edge, midpoint to midpoint, and edge to midpoint. Alignment between an object and text may be achieved using guides which are automatically displayed when a point of the bounding box of an object is aligned with the text baseline. In some implementations, automatically displayed guides can create friction or gravity on-the-fly to assist the user when aligning moving objects with positioned objects and/or text.

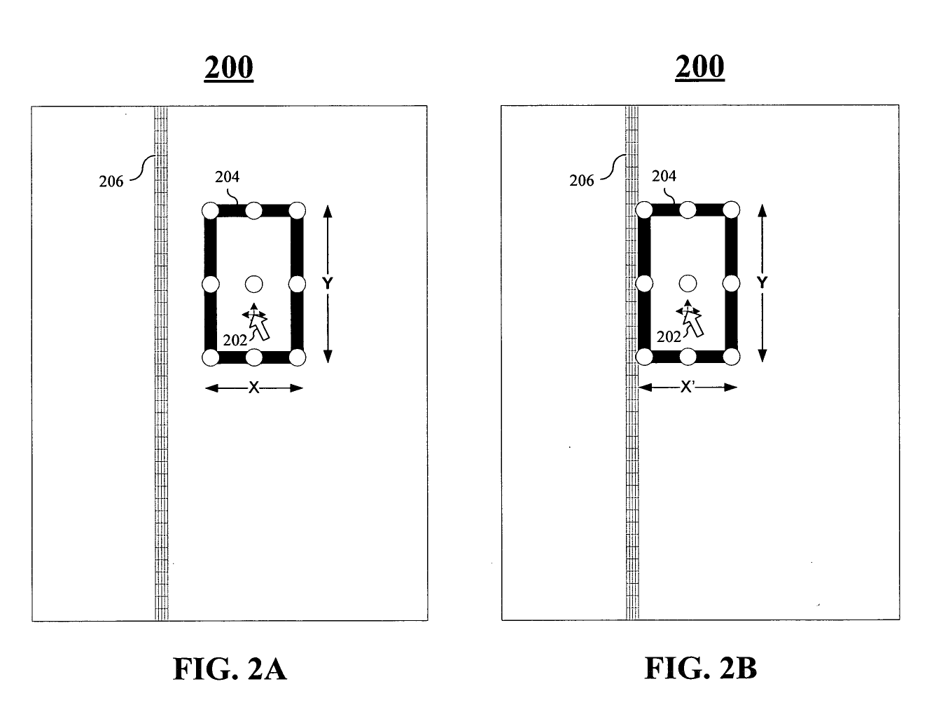

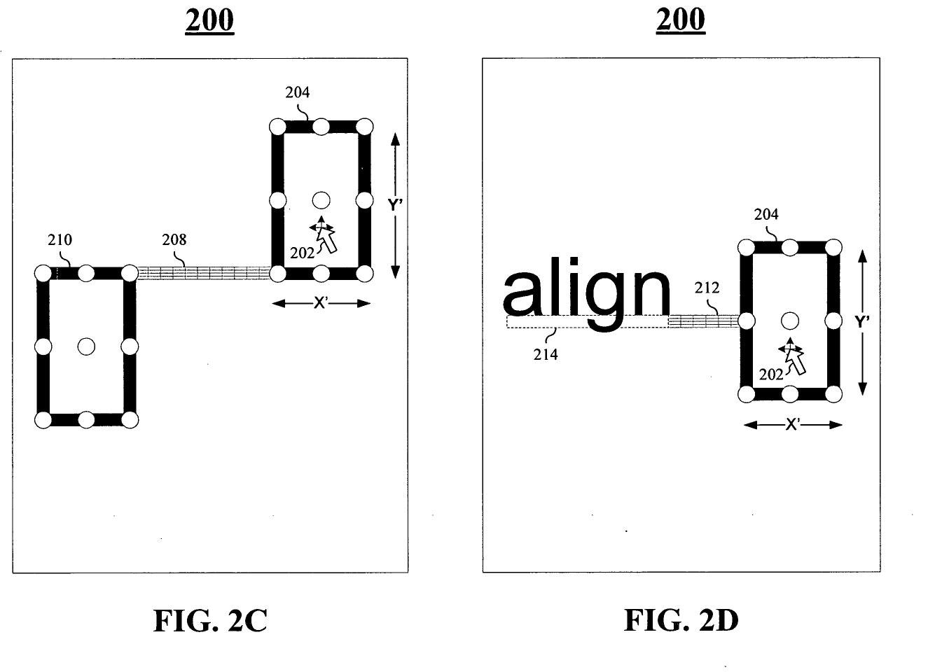

FIGS. 2A and 2B illustrate an exemplary GUI 200. In various implementations, the GUI 200 may be presented on the display 104 of the computer system 100. As shown, the GUI 200 may comprise a pointer 202 to select a movable object 204 and a guide 206 to align the movable object 204 at a target position. The object 204 may be defined by a rectangular bounding box comprising nine points including the four vertices and four midpoints of the boundary and the center of the object 204. Each of the nine points of the rectangular bounding box may be used individually to determine the position of the object 204 and to make movement calculations.

In this embodiment, the guide 206 may comprise a single pixel wide vertical guideline, and the pixels of the guide 206 may be configured with a friction coefficient (μ) for modifying a standard object movement rate of the selected object 204. The selected object 204 is capable of being positioned at any pixel of the guide 206 configured with the friction coefficient (μ). The pixels on either side of the guideline 206 are not configured with the friction coefficient (μ) and exhibit normal behavior.

Referring to FIG. 2A, the movable object 204 is selected by the pointer 202 and is moved toward the guide 206 without intersecting. In this case, user movement received in the horizontal direction is translated into a standard horizontal object movement rate (X), and user movement received in the vertical direction is translated into a standard vertical object movement rate (Y).

Referring to FIG. 2B, the edge of the selected object 204 intersects with the pixels of the guide 206 that are configured with the friction coefficient, and the standard object movement rate is modified according to the frictional coefficient (μ). User movement received in the horizontal direction may be translated according to a horizontal component (μ_{H}) of the friction coefficient (μ) resulting in modified horizontal object movement rate (X′). User movement received in the vertical direction may be translated according to the vertical component (μ_{V}) of the friction coefficient (μ) resulting in modified vertical object movement rate (Y′). If the horizontal component (μ_{H}) and the vertical component (μ_{V}) are equal, the pixels of the guide 206 exhibits uniform, non-directional friction.

As the edge of the moving object 204 touches the guide 206, the virtually subdivided pixels of the guide are accounted for transparently to the user. The object 204 experiences a hesitation at the guide 206, and more user movement and time are required to move the object 204 across the guide 206. The slowing of the moving object 204 provides the user with the opportunity for more precise positioning.

FIG. 2C illustrates another embodiment of GUI 200. As shown, the GUI 200 may comprise a pointer 202 to select a movable object 204 defined by a rectangular bounding box comprising nine points including the four vertices and four midpoints of the boundary and the center of the object 204.

In this embodiment, a guide 208 may comprise a horizontal guideline which is displayed automatically when the movable object 204 is aligned with a positioned object 210 defined by a rectangular bounding box. The pixels of the guide 208 may be configured with a friction coefficient (μ) for modifying a standard object movement rate of the selected object 204. The selected object 204 is capable of being positioned at any pixel of the guide 208 configured with the friction coefficient (μ).

In this case, the edge of the movable object 204 intersects with the pixels of the guide 208 when the edge of the movable object 204 is aligned with the edge of the positioned object 210. The standard object movement rate is modified according to the frictional coefficient (μ). For example, horizontal user movement may be translated according to a horizontal component (μ_{H}) of the friction coefficient (μ) resulting in a modified horizontal object movement rate (X′). User movement received in the vertical direction may be translated according to the vertical component (μ_{V}) of the friction coefficient (μ) resulting in a modified vertical object movement rate (Y′).

J As the edge of the moving object 204 touches the guide 208, the virtually subdivided pixels of the guide 208 are accounted for transparently to the user. The object 204 experiences a hesitation at the guide 208, and user movement and time are required to move the object 204 across the guide 208. The slowing of the moving object 204 provides the user with the opportunity for more precise alignment with respect to the positioned object 210.

FIG. 2D illustrates another embodiment of GUI 200. As shown, the GUI 200 may comprise a pointer 202 to select a movable object 204 defined by a rectangular bounding box comprising nine points including the four vertices and four midpoints of the boundary and the center of the object 204.

In this embodiment, a guide 212 may comprise a horizontal guideline which is displayed automatically when the movable object 204 is aligned with a text baseline 214. The pixels of the guide 212 may be configured with a friction coefficient (μ) for modifying a standard object movement rate of the selected object 204. The selected object 204 is capable of being positioned at any pixel of the guide 212 configured with the friction coefficient (μ).

In this case, the movable object 204 intersects with the pixels of the guide 208 when the midpoint of the movable object 204 is aligned with the text baseline 214. The standard object movement rate is modified according to the frictional coefficient (μ). For example, horizontal user movement may be translated according to a horizontal component (μ_{H}) of the friction coefficient (μ) resulting in a modified horizontal object movement rate (X′). User movement received in the vertical direction may be translated according to the vertical component (μ_{V}) of the friction coefficient (μ) resulting in a modified vertical object movement rate (Y′).

As the moving object 204 touches the guide 212, the virtually subdivided pixels of the guide 212 are accounted for transparently to the user. The object 204 experiences a hesitation, and more user movement and time are required to move the object 204 through the guide 212. The slowing of the moving object 204 provides the user with the opportunity for more precise alignment with respect to the text baseline 214.

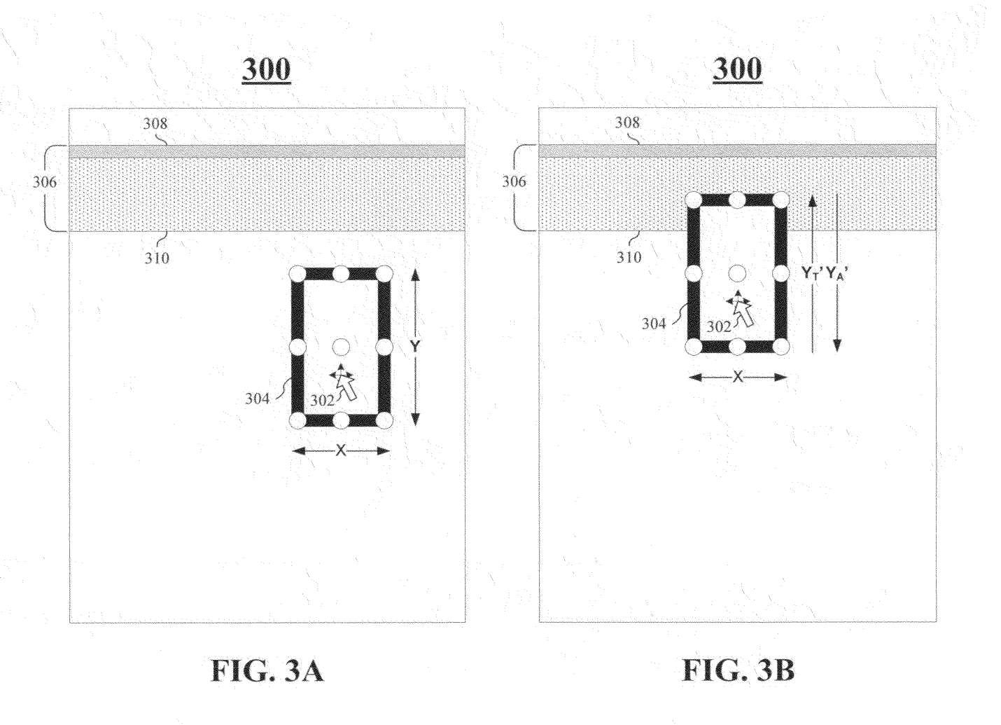

FIGS. 3A and 3B illustrate an exemplary GUI 300. In various implementations, the GUI 300 may be presented on the display 104 of the computer system 100. As shown, the GUI 300 may comprise a pointer 302 to select a movable object 304 and a guide 306 to align the movable object 304 at a target position. The object 304 may be defined by a rectangular bounding box comprising nine points including the four vertices and four midpoints of the boundary and the center of the object 304. Each of the nine points of the rectangular bounding box may be used individually to determine the position of the object 304 and to make movement calculations.

In this embodiment, the guide 306 may comprise a single pixel wide horizontal guideline 308 and a region of influence 310 adjacent to a horizontal guideline. The pixels defining the region of influence 310 may be configured with a gravity coefficient (g) for modifying a standard object movement rate of the selected object 304. The selected object 304 is capable of being positioned at any pixel of the guide 306 including the horizontal guideline 308 and the region of influence 310 configured with the gravity coefficient (g). The pixels below the region of influence 310 are not configured with the gravity coefficient (g) and exhibit normal behavior.

Referring to FIG. 3A, the movable object 304 is selected by the pointer 302 and is moved toward the guide 306 without intersecting the region of influence 308. In this case, user movement received in the horizontal direction is translated into a standard horizontal object movement rate (X), and user movement received in the vertical direction is translated into a standard vertical object movement rate (Y).

Referring to FIG. 3B, the edge of the selected object 304 intersects with the pixels of the region of influence 310 that are configured with the gravity coefficient (g). The standard object movement rate may be modified according to the gravity coefficient (g) such that the corresponding object movement rate is accelerated toward the horizontal guideline 308. It can be appreciated that the object 304 passes through and may be positioned at every pixel within the region of influence 310. Even when accelerated, the object 304 ultimately may be stopped within the region of influence 310.

User movement received in the vertical direction toward the horizontal guideline 308 may be translated according to a toward factor (g_{T}) of the gravity coefficient (g) resulting in a modified toward vertical object movement rate (Y_{T}′). User movement received in the vertical direction away from the guide may be translated according to an away factor (g_{A}) of the gravity coefficient (g) resulting in modified away vertical object movement rate (Y_{A}′).

In this embodiment, user movement received in a direction parallel to the horizontal guideline 306 may be translated into the standard horizontal object movement rate (X). In other embodiments, a vertical component may be added to horizontal object movement rate so that the movement of the object 304 will bend upwards toward the horizontal guideline 306. In some implementations, the gravity coefficient (g) may be configured to provide no resistance to movement in a direction away from the field of influence 310.

Operations for various embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the computing system 100 or alternative elements as desired for a given set of design and performance constraints.

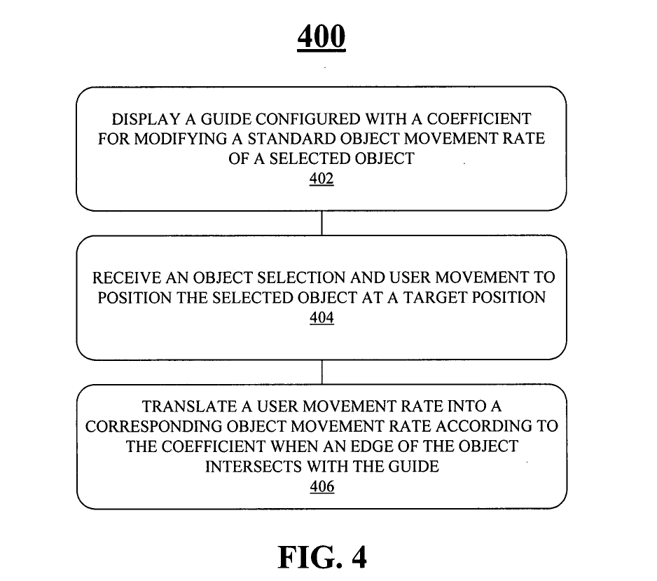

FIG. 4 illustrates a logic flow 400 representative of the operations executed by one or more embodiments described herein. As shown in FIG. 4, the logic flow 400 may comprise displaying a guide configured with a coefficient for modifying a standard object movement rate of a selected object (block 402). The guide may be displayed to a user on a GUI comprising a pointer to select a movable object and to align a selected object at a target position on the GUI. The logic flow 400 may comprise receiving an object selection and user movement to position the selected object at a target position (block 404). The logic flow 400 may comprise translating a user movement rate into a corresponding object movement rate according to the coefficient when an edge of the object intersects with the guide (block 406).

In some embodiments, the user movement rate is translated into a corresponding object movement rate which is slower than the standard object movement rate according to a friction coefficient. In other embodiments, the user movement rate is translated into a corresponding object movement rate which is faster than the standard object movement rate according to a gravity coefficient. In various implementations, when an edge of the selected object intersects with an area of influence defined by the pixels configured with the gravity coefficient, the corresponding object movement rate is accelerated in a direction toward a plurality of collinear guide pixels adjacent to the area of influence. The embodiments are not limited in this context.

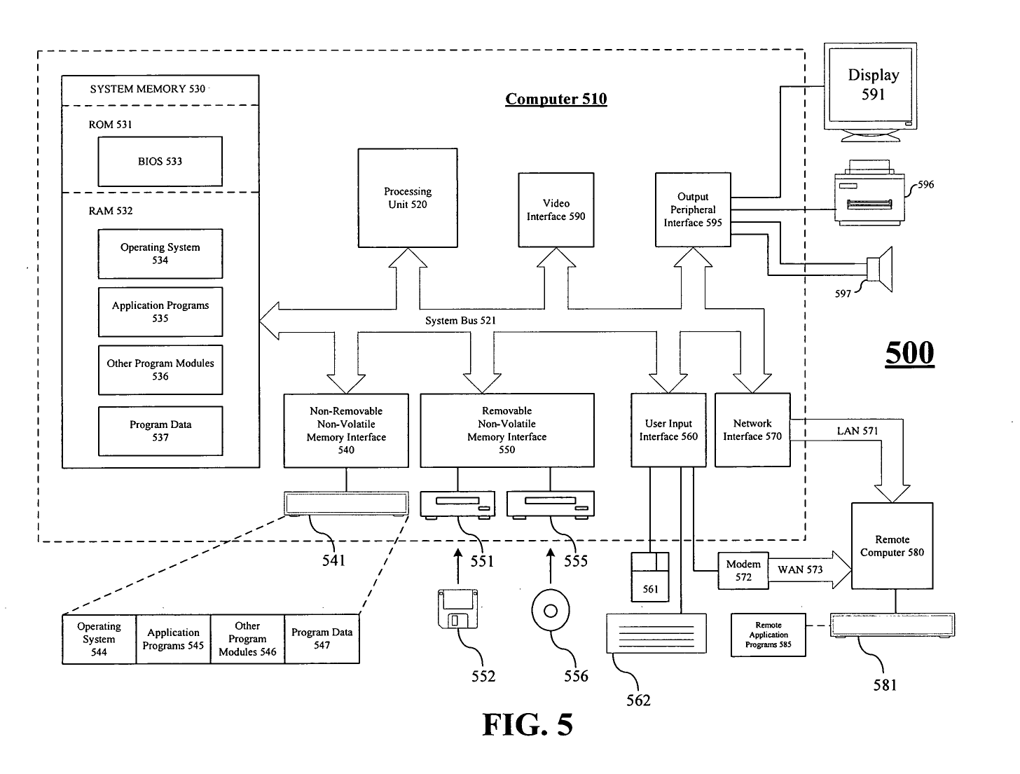

FIG. 5 illustrates a computing system architecture 500 suitable for implementing various embodiments, including the various elements of the computer system 100. It may be appreciated that the computing system architecture 500 is only one example of a suitable computing environment and is not intended to suggest any limitation as to the scope of use or functionality of the embodiments. Neither should the computing system architecture 500 be interpreted as having any dependency or requirement relating to any one or combination of components illustrated in the exemplary computing system architecture 500.

As shown in FIG. 5, the computing system architecture 500 includes a general purpose computing device such as a computer 510. The computer 510 may include various components typically found in a computer or processing system. Some illustrative components of computer 510 may include, but are not limited to, a processing unit 520 and a system memory unit 530.

In one embodiment, for example, the computer 510 may include one or more processing units 520. A processing unit 520 may comprise any hardware element or software element arranged to process information or data. Some examples of the processing unit 520 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 520 may be implemented as a general purpose processor. Alternatively, the processing unit 520 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 510 may include one or more system memory units 530 coupled to the processing unit 520. A system memory unit 530 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can be accessed by computer 510. The embodiments are not limited in this context.

In one embodiment, for example, the computer 510 may include a system bus 521 that couples various system components including the system memory unit 530 to the processing unit 520. A system bus 521 may be any of several types of bus structures including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 510 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 500. Examples of computer readable media for computing system architecture 500 may include, but are not limited to, volatile and/or nonvolatile memory such as ROM 531 and RAM 532. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the system memory unit 530 includes computer storage media in the form of volatile and/or nonvolatile memory such as ROM 531 and RAM 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/non-volatile computer storage media. By way of example only, FIG. 5 illustrates a hard disk drive 541 that reads from or writes to non-removable, non-volatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. The hard disk drive 541 is typically connected to the system bus 521 through a non-removable memory interface such as non-removable, non-volatile memory interface 540. The magnetic disk drive 551 and optical disk drive 555 are typically connected to the system bus 521 by a removable memory interface, such as removable, non-volatile memory interface 550. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB). A display 591 such as a monitor or other type of display device is also connected to the system bus 521 via an interface, such as a video interface 590. In addition to the display 591, computers may also include other peripheral output devices such as printer 596 and speakers 597, which may be connected through an output peripheral interface 595.

The computer 510 may operate in a networked environment using logical connections to one or more remote computers, such as a remote computer 580. The remote computer 580 may be a PC, a server, a router, a network PC, a peer device or other common network node, and typically includes many or all of the elements described above relative to the computer 510, although only a memory storage device 581 has been illustrated in FIG. 5 for clarity. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface 570 or adapter. When used in a WAN networking environment, the computer 510 typically includes a modem 572 or other technique suitable for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other techniques for establishing a communications link between the computers may be used. Further, the network connections may be implemented as wired or wireless connections. In the latter case, the computing system architecture 500 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Various embodiments may be implemented using hardware elements, software elements, or a combination of both. Examples of hardware elements may include logic devices, microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

In some cases, various embodiments may be implemented as an article of manufacture. The article of manufacture may be implemented, for example, as a computer-readable storage medium storing logic and/or data for performing various operations of one or more embodiments. The computer-readable storage medium may include one or more types of storage media capable of storing data, including volatile memory or, non-volatile memory, removable or non-removable memory, erasable or non-erasable memory, writeable or re-writeable memory, and so forth. The computer-readable medium may store logic comprising instructions, data, and/or code that, if executed by a computer system, may cause the computer system to perform a method and/or operations in accordance with the described embodiments. Such a computer system may include, for example, any suitable computing platform, computing device, computer, processing platform, processing system, processor, or the like implemented using any suitable combination of hardware and/or software.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. It is worthy to note that although some embodiments may describe structures, events, logic or operations using the terms “first,” “second,” “third,” and so forth, such terms are used merely as labels, and are not intended to impose numerical requirements on their objects. Further, such terms are used to differentiate elements and not necessarily limit the structure, events, logic or operations for the elements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer system comprising:
a display to present a graphical user interface with a pointer to select a movable object and a guide to align a selected object at a target position, the guide comprising one or more pixels configured with a coefficient to modify a standard object movement rate of the selected object, the selected object capable of being positioned at any pixel configured with the coefficient;
an input device to receive an object selection and user movement to position the selected object at the target position on the graphical user interface; and
an alignment module to translate a user movement rate into a corresponding object movement rate according to the coefficient when an edge of the selected object intersects with any pixel configured with the coefficient.

2. The computer system of claim 1, the guide comprising at least one of a guideline, a guide region, a shape guide, and a text baseline.

3. The computer system of claim 1, the guide extending between the selected object and a positioned object on the graphical user interface, the guide displayed when an edge or midpoint of the selected object aligns with an edge or midpoint of the positioned object.

4. The computer system of claim 1, the coefficient comprising a friction coefficient to translate the user movement rate into a corresponding object movement rate that is slower than the standard object movement rate.

5. The computer system of claim 1, the coefficient comprising a gravity coefficient to translate the user movement rate into a corresponding object movement rate that is faster than the standard object movement rate.

6. The computer system of claim 5, wherein pixels configured with the gravity coefficient define an area of influence adjacent to a plurality of collinear guide pixels, the gravity coefficient to accelerate the corresponding object movement rate in a direction toward the plurality of collinear guide pixels when an edge of the selected object intersects with the area of influence.

7. The computer system of claim 6, the alignment module to translate user movement rate into the standard movement rate when the selected object is within the area of influence upon receiving user movement in a direction away from the collinear guide pixels.

8. The computer system of claim 6, the alignment module to translate user movement rate into the standard movement rate when the selected object is within the area of influence upon receiving user movement in a direction parallel to the collinear guide pixels.

9. The computer system of claim 6, the alignment module to translate user movement rate according to a toward factor of the gravity coefficient for user movement received in a direction perpendicular to and toward the collinear guide pixels and to translate user movement rate according to an away factor of the gravity coefficient for user movement received in a direction perpendicular to and away from the collinear guide pixels.

10. The computer system of claim 1, further comprising an application to enable user selection of one or more guides from one or more guide templates.

11. The computer system of claim 10, the application to automatically display one or more guides in response to object selection and user movement.

12. The computer system of claim 10, the application to enable configuration of the coefficient associated with the guide to vary behavior of the guide.

13. A method, comprising:
displaying a pointer to select a movable object and a guide to align a selected object at a target position on a graphical user interface, the guide comprising a plurality of collinear pixels configured with a coefficient for modifying a standard object movement rate of the selected object;
receiving an object selection and user movement to position the selected object at the target position on the graphical user interface; and
translating a user movement rate into a corresponding object movement rate according to the coefficient when an edge of the object intersects with the guide.

14. The method of claim 13, comprising translating the user movement rate into a corresponding object movement rate which is slower than the standard object movement rate according to a friction coefficient.

15. The method of claim 13, comprising translating the user movement rate into a corresponding object movement rate which is faster than the standard object movement rate according to a gravity coefficient.

16. The method of claim 15, comprising:
determining when an edge of the selected object intersects with an area of influence defined by the pixels configured with the gravity coefficient, the area of influence adjacent to a plurality of collinear guide pixels; and
accelerating the corresponding object movement rate in a direction toward the plurality of collinear guide pixels intersects with the area of influence.

17. An article comprising a computer-readable storage medium storing instructions that if executed enable a computer system to:
display a graphical user interface with a pointer to select a movable object and a guide to align a selected object at a target position, the guide comprising a plurality of collinear pixels configured with a coefficient for modifying a standard object movement rate of the selected object;
receive an object selection and user movement to position the selected object at the target position on the graphical user interface; and
translate a user movement rate into a corresponding object movement rate according to the coefficient when an edge of the object intersects with the guide.

18. The article of claim 17, further comprising instructions that if executed enable the computer system to translate the user movement rate into a corresponding object movement rate which is slower than the standard object movement rate according to a friction coefficient.

19. The article of claim 17, further comprising instructions that if executed enable the computer system to translate the user movement rate into a corresponding object movement rate which is faster than the standard object movement rate according to a gravity coefficient.

20. The article of claim 19, further comprising instructions that if executed enable the computer system to:
determine when an edge of the selected object intersects with an area of influence defined by the pixels configured with the gravity coefficient, the area of influence adjacent to a plurality of collinear guide pixels; and
accelerate the corresponding object movement rate in a direction toward the plurality of collinear guide pixels intersects with the area of influence.
